(19) United States
(12) Patent Application Publication
(10) Pub. No.: US 2008/0011405 A1
(43) Pub. Date: Jan. 17, 2008

(54) Method of decorating an article and sheet used for the transfer

(76) Inventor: Jean-Noel Claveau, Coisia (FR)

Correspondence Address: BLANK ROME LLP, 600 NEW HAMPSHIRE AVENUE, N.W., WASHINGTON, DC, 20037, US

(21) Appl. No.: 10/562,332

(22) PCT Filed: Jun. 24, 2004
(86) PCT No.: PCT/FR04/01598

§ 371 Date: Mar. 26, 2007

(30) Foreign Application Priority Data
Jun. 26, 2003 (FR) 03/50260

(51) Int. Cl. B32B 37/00

(52) U.S. Cl. 156/87; 428/195.1

(57) ABSTRACT

The invention relates to a method of decorating an article. The inventive method includes the steps of preparing a transfer sheet by printing the same with at least one heat-activated ink and applying the sheet to an article to be decorated and heating the assembly. The invention is characterized in that the transfer sheet includes a flocked material. A transfer sheet, used to implement the invention, is also disclosed.

This invention relates to the decoration of articles by means of transferring heat-activated inks, in particular sublimable inks.

The general principle is known through several patents of the previous technique, and in particular from patents registered by the patentee.

U.S. Pat. No. 5,665,458, U.S. Pat. No. 4,314,813 and DE19709496 describe transfer methods using contact, according to a technique that is similar to that used in stamps. A substrate with flocked fibres retains an ink to be transferred onto a surface to be decorated. This solution is not fully satisfactory, since it does not allow decoration of awkward surfaces and requires the application of pressure with the help of a matrix that matches the profile of the surface to be decorated.

The aim of this invention is to remedy the disadvantages of the solutions of the previous technique by providing an improved method and improved transfer sheets.

For this purpose, the invention relates, according to its most general aspect, to decoration of an article comprising a step that consists of preparing a transfer sheet by printing it with at least one heat-activated ink, a transfer step consisting of applying said sheet to the article to be decorated, and then heating the assembly, characterised in that said transfer sheet consists of a flocked material and a transfer step in which the transfer sheets forms a watertight envelope around the article to be decorated, which is connected to a depression spring.

The transfer sheet used to implement the method is mainly made up of:
a flocked elastomer
a flocked natural latex
a flocked synthetic latex
a sheet of flocked natural polyisoprene.

The flocks consist of:
cotton fibres
viscose fibres
polyamide fibres
acrylic fibres
polyester fibres.

The invention will be understood better from reading the following description, relating to non-exhaustive examples of embodiments of the invention.

The decoration of an article requires a succession of operations. The first operation consists of preparing a blank transfer support.

The transfer support is an elastomer, resistant to the temperatures required for sublimation of the ink. This can be a sheet of natural or synthetic latex (neoprene, nitrile rubber), PVC (polyvinyl chloride) or vinyl. These components can be mixed in order to optimise their resistance.

It can also consist of a synthetic polymer which has been given characteristics that are similar to those of natural latex by means of vulcanisation, and resulting from the combination of several monomers: acrylonitrile, butadiene and, possibly, carboxylic acid with zinc oxide.

It can also consist of a synthetic high-performance elastomer obtained by polymerisation of a chlorinated compound: polychloroprene.

This membrane is flocked by a method that consists of placing a film of glue on the surface of the membrane and then placing short textile fibres on the glued surface.

The film thus prepared enables printing with sublimable ink, by means of a traditional image-transfer method, such as photogravure, silk-screen printing or simply printing with an inkjet printer.

The image, digitised and processed by a computer, is printed with a special sublimable ink in a professional inkjet printer or any other ad hoc printing equipment.

Sublimable inks consist generally of molecules that are modest in terms of size and mass, with a compromise between the existence of conjugated double bonds and conjugated cycles that enables the molecules to be coloured and the molecular masses to be reduced so that the molecules are compatible with the sublimation process.

It is also possible, when printing the transfer sheet, to use phase-change inks and, more particularly, thermofusible inks.

The printed transfer sheet is then applied to the article to be decorated.

It preferably surrounds the article in a watertight fashion so as to form a watertight envelope inside which a vacuum is created. The sheet surrounding the article to be decorated is connected for this purpose, by means of a tube, to a vacuum pump or to a depression spring, so as to assure that the printed surface is applied against the surface of the article to be decorated.

The flocked fibres form a porous cavity that allows the passage of air when the depression is applied. The lack of a structure in the flocking stops the article from being marked with a raster, as was the case with the previous technique.

Next, the assembly is heated to a compatible temperature and duration required for transferring the heat-activated ink.

In the absence of indications supplied by the distributor of the heat-activated ink, the skilled worker will know, by means of simple routine tests, how to determine the optimum conditions. For this, an initial temperature and duration will be selected, for example 180° for 2 seconds, and this will be increased by regular amounts, for example, by 5° C. and 0.5 seconds, until a plateau is reached in the quality of the transfer.

The heating can be assured by a flow of hot air or by immersion in a hot liquid.

The assembly formed by the transfer sheet and the article to be decorated is advantageously plunged into a bath of a nonferrous-metal alloy with a low melting point. This can be, for example, an alloy consisting of bismuth, lead, tin and cadmium (Bi 50%, Pb 25%, Sn 12.5%, Cd 12.5%), which has a melting point of around 70° C., maintained at a temperature of around 190° C.

1. A method of decorating an article, comprising the steps of:
preparing a transfer sheet by printing it with at least one heat-activated ink;
applying said sheet to the article to be decorated; and
heating this assembly,
wherein said transfer sheet is made up of a flocked material and further comprising a transfer step in which the transfer sheet forms a watertight envelope around the article to be decorated, which is connected to a depression spring.

2. The method of decorating an article according to claim 1, wherein said flocked material is a flocked elastomer.

3. The method of decorating an article according to claim 1, wherein said flocked material is a flocked natural latex.

4. The method of decorating an article according to claim 1, wherein said flocked material comprises a flocked synthetic latex.

5. The method of decorating an article according to claim 1, wherein said flocked material comprises a sheet of flocked natural polyisoprene.

6. The method of decorating an article according to claim 1, wherein said flocked material comprises a sheet of flocked natural polyisoprene.

7. The method of decorating an article according to claim 1, wherein the flocks comprise cotton fibres.

8. The method of decorating an article according to claim 1, wherein the flocks comprise viscose fibres.

9. The method of decorating an article according to claim 1, wherein the flocks comprise polyamide fibres.

10. The method of decorating an article according to claim 1, wherein the flocks comprise acrylic fibres.

11. The method of decorating an article according to claim 1, wherein the flocks comprise polyester fibres.

12. The method of decorating an article according to claim 1, wherein the heat-activated ink is a sublimable ink.

13. The method of decorating an article according to claim 1, wherein the heat-activated ink is of the “thermofusible” type.

14. The method of decorating an article according to claim 1, wherein the heating in order to activate the ink during the transfer step is assured by immersion in an alloy of nonferrous metals.

15. The method of decorating an article according to claim 14, wherein the heating to activate the ink during the transfer step is assured by immersion in an alloy consisting of bismuth, lead, tin and cadmium (Bi 50%, Pb 25%, Sn 12.5%, Cd 12.5%), which has a melting point of around 70° C., maintained at a temperature of around 190° C.

16. (canceled)

17. A transfer sheet for implementing the method according to claim 1, wherein the transfer sheet comprises a flocked elastomer.

18. A transfer sheet for implementing the method according to claim 1, wherein the transfer sheet comprises a flocked natural latex.

19. A transfer for implementing the method according to claim 1, wherein the transfer sheet comprises a flocked synthetic latex.

20. A transfer sheet for implementing the method according to claim 1, wherein the transfer sheet comprises a sheet of flocked natural polyisoprene.

21. The transfer sheet according to claim 17, wherein the flocks comprise at least one of cotton fibres, viscose fibres, polyamide fibres, acrylic fibres and polyester fibres.

22-25. (canceled)
